(19) United States
(12) Patent Application Publication
(10) Pub. No.: US 2007/0063635 A1
(43) Pub. Date: Mar. 22, 2007

(54) Quenched Phosphor Displays

(75) Inventor: John L. Janning, Dayton, OH (US)

Correspondence Address: DYKEMA GOSSETT PLLC, 39577 WOODWARD AVENUE, SUITE 300, BLOOMFIELD HILLS, MI, 48304-5086, US

(73) Assignee: St. Clair Intellectual Property Consultants, Inc., Grosse Pointe, MI (US)

(21) Appl. No.: 11/306,974

(22) Filed: Jan. 18, 2006

Related U.S. Application Data
(60) Provisional application No. 60/688,314, filed on Jun. 6, 2005.

(51) Int. Cl. H01J 63/04

(52) U.S. Cl. 313/497

(57) ABSTRACT

Displays are described comprising electrically quenched phosphor pixels, in which light emissions by a phosphor pixel are inhibited by application of an electric field. Such pixels may be excited by UV and de-excited by applying a voltage to control the display.

### CROSS-REFERENCE TO RELATED APPLICATIONS

Benefit of priority is claimed based on U.S. Provisional Application No. 60/688,314 filed Apr. 05, 2005, titled “Quenched Phosphor Display.”

### BACKGROUND

It is known that the application of an AC or DC potential can quench or inhibit fluorescence of phosphors, e.g., of the ZnS group. The phenomenon has been observed for electric fields applied both during and after phosphor excitation with ultraviolet (UV) light. See, e.g., Daniel, P. J., et al., “Control of Luminescence by Charge Extraction,” Physical Review, Volume 111, Number 5, Sep. 1, 1958, pages 1240-1244; and Kallmann, H., et al., “De-Excitation of ZnS and ZnCdS Phosphors by Electric Fields,” Physical Review, Volume 109, Number 3, Feb. 1, 1958, pages 721-729.

Luminescent light emissions from phosphors have been widely used in displays of various types, including CRTs, ELDs, FEDs and plasma displays for home and business use. Such displays have generally operated by controlled excitation of the phosphors, either by applied radiation or electron bombardment, creating a pattern on a phosphor pixel array.

### SUMMARY

Displays are described comprising electrically quenched phosphor pixels, in which light emissions by a phosphor pixel are inhibited by application of an electric field. Such pixels may be excited by UV and de-excited by applying a voltage to control the display.

Advantages, variations and other features of the invention will become apparent from the drawings, the further description of examples and the claims to follow.

### BRIEF DESCRIPTION OF THE DRAWINGS

FIG. 1a shows a sectional side view of an exemplary pixel cell structure in which a pixel phosphor is excited from behind by application of UV radiation.

FIG. 1b shows the exemplary pixel cell structure of FIG. 1a in which the fluorescence of the pixel phosphor is quenched by an applied electric field.

FIG. 2 is an enlarged sectional view of the cell structure of FIGS. 1a and 1b.

### DETAILED DESCRIPTION

Exemplary displays are described where radiation excitable phosphors are used and quenched in selected areas or pixels. Quenching of a UV excited phosphor may be accomplished by applying an electric field across the excited phosphor. Preferably, the electric field is sourced by direct current (DC) voltage although alternating current (AC) voltage could be used in selected applications, e.g., to inhibit excitation “recovery”.

It is known that certain phosphors—such as ZnS compounds, for example—under UV excitation, can be quenched (or de-excited) by thermal means and/or by an electric field. The use of these phenomena for construction of displays will be further described.

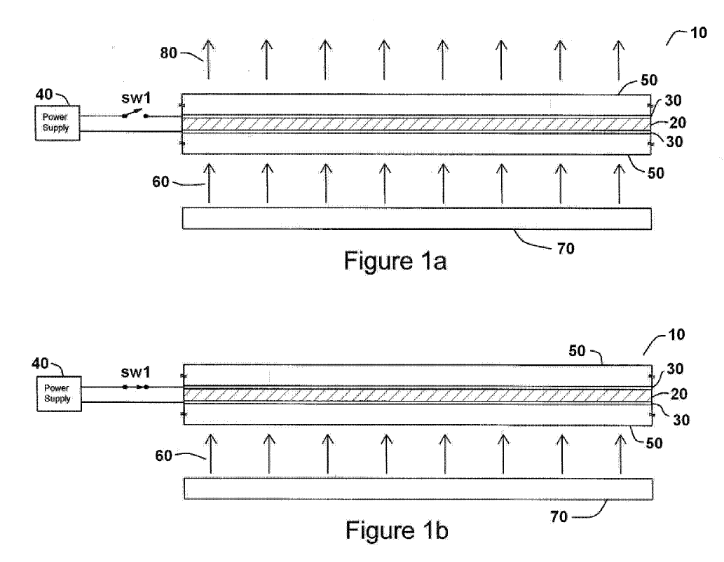

FIG. 1a and FIG. 1b depict an exemplary thin film “electroluminescent type” cell structure configuration 10 for a phosphor-based pixel in a display. The illustrated construction 10 is similar to an electroluminescent (EL) cell but the operation is different.

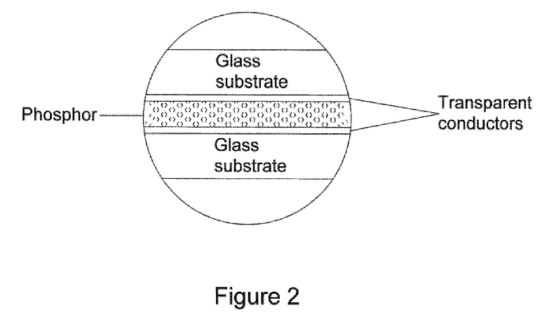

The illustrated phosphor 20 is disposed between transparent conductive coatings 30 which serve as electrodes and apply an electronic quenching field sourced by a power supply 40 upon closure of a switch SW1. The phosphor 20 and the conductive coatings 30 are in turn disposed between glass plates or substrates 50 as shown in FIGS. 1a, 1b and 2. Ultraviolet (UV) radiation 60 from a UV light source 70 such as an LED impinging on the phosphor excites the phosphor 20 to emit light 80 of its own frequency.

As shown in FIGS. 1a and 1b, UV light 60 is projected at the phosphor 20 from behind through the lower glass plate substrate 50. Resulting fluorescence or light emissions 80 by the excited phosphor 20 are emitted through the upper transparent conductive coating 30 and glass plate substrate 50 when the switch SW1 is open as shown in FIG. 1a. Closure of switch SW1 quenches the phosphor 20, inhibiting light emissions to control the display as shown in FIG. 1b. A voltage is applied across the phosphor pixel cell structure 10, with the closing of switch SW1, inhibiting the applied UV light 60 from exciting and thus “quenching” the phosphor 20.

Note that in FIG. 1a, the UV light 60 excites the phosphor 20 where the light exciting the phosphor 20 is generally the ‘converted’ light frequency from the phosphor 20. As shown, the UV light 60 can excite the phosphor 20 to emit photons of the phosphor's inherent frequency without passing through the excited phosphor 20.

Different phosphors emit different light wavelengths—even though excited by the same UV source. Different phosphors may accordingly be used to construct different color displays, or full color displays, as in other phosphor-based display technologies.

FIGS. 1a, 1b and 2 illustrate an exemplary cell structure 10 for one pixel. Many pixels could be constructed in a matrix as in other types of displays to display a picture for a flat panel television, laptop computer, cell phone, gas pump display or the like. To differentiate between pixels, areas between the pixels can be darkened, or not have any phosphor deposited, or have the phosphor removed selectively, using well known methods.

Normally, in a light emitting display, the screen is dark and selected areas or pixels are lit to display a picture or data. In a display using electrically quenched phosphor pixels, the entire screen can be “lit” (excited by UV) and selected areas or pixels are quenched to inhibit or “turn off the light” to create the pattern. Phosphors excited by UV radiation can be quite bright. The common fluorescent light is a good example of this.

While FIGS. 1a and 1b depict the use of an ultraviolet light source to excite the phosphors, the entire cell could be constructed inside of a “fluorescent type” light. In such a construction, a plasma or ionized gas emitting ultraviolet radiation would excite the phosphors internally. Quenching of the phosphors in this type of display cell could yield very high contrast ratios. Other potential sources of UV light include LEDs as is well known.

The invention can be carried out as described in examples above and in many other embodiments not specifically described here. A very wide variety of embodiments is thus possible and is also within the scope of the following appended claims.

What is claimed is:

1. A display comprising electrically quenched phosphor pixels, in which light emissions by a phosphor pixel are inhibited by application of an electric field.

2. The display of claim 1 in which said pixels are excited by UV light.

3. The display of claim 2 in which a source of said UV light comprises an LED.

4. The display of claim 2 in which a source of said UV light is excited plasma.

5. The display of claim 2 in which said pixels are inside a fluorescent light.

6. The display of claim 1 in which said electric field is a DC electric field.

7. The display of claim 1 in which said electric field is an AC electric field.

8. The display of claim 1 in which said phosphor pixels comprise ZnS.

9. The display of claim 1 in which said pixels comprise thin film cell structures.

10. The display of claim 2 in which said pixels comprise thin film cell structures and said UV light does not pass through said cell structures but excites said phosphor pixels to emit photons at the inherent frequency of the phosphor pixels.

11. The display of claim 1 in which said pixels are constructed in a matrix.

12. The display of claim 1 in which said pixels are electrically quenched to turn off emitted light.

13. The display of claim 1 having darkened areas between said pixels.

14. The display of claim 1 in which areas between said pixels are devoid of phosphor.

15. The display of claim 1 in which phosphor is selectively removed between said pixels.

16. The display of claim 1 in which said phosphor pixels comprise a pixel cell constructed inside a fluorescent light.

17. The display of claim 16 in which ionized gas emits UV radiation exciting said pixels.

18. The display of claim 16 in which UV radiation is emitted inside said fluorescent light.

19. The display of claim 1 in which said phosphor pixels are disposed between transparent conductive coatings.

20. The display of claim 19 in which said electric field is created by an electric potential applied across said coatings.

21. The display of claim 19 in which said phosphor pixels emit fluorescent light through a glass faceplate overlying one of said transparent conductive coatings.

22. The display of claim 19 in which said phosphor pixels are excited by UV light emitted through a glass plate overlying one of said transparent conductive coatings.

23. The display of claim 19 in which said pixels are disposed between glass substrates.

24. The display of claim 19 in which said transparent conductive coatings and said pixels are disposed between a pair of glass substrates.

25. The display of claim 24 in which said phosphor pixels emit fluorescent light through one of said glass substrates.

26. The display of claim 24 in which said phosphor pixels are excited by UV light projected through another of said glass substrates.

27. The display of claim 1 in which said phosphor pixels are excited by application of UV light through edge lighting of said display.

28. A display in which fluorescence of phosphor pixels is excited by UV radiation and inhibited by quenching with an electric field to control the display.
